(19) United States
(12) Patent Application Publication
(10) Pub. No.: US 2020/0004338 A1
(43) Pub. Date: Jan. 2, 2020

(54) DATA PROCESSING METHOD AND ELECTRONIC DEVICE

(71) Applicant: Lenovo (Beijing) Co., Ltd., Beijing (CN)

(72) Inventor: Qian ZHAO, Beijing (CN)

(21) Appl. No.: 16/454,462

(22) Filed: Jun. 27, 2019

(30) Foreign Application Priority Data
Jun. 29, 2018 (CN) 201810714482.5

(51) Int. Cl. G06F 3/01; G06T 7/73; G06T 19/20

(52) U.S. Cl. CPC G06F 3/016; G06F 3/011; G06T 19/20; G06T 7/73

(57) ABSTRACT

A data processing method and an electronic device are provided. The data processing method comprises acquiring a real scene; presenting a target virtual object corresponding to a sphere of influence in the real scene; obtaining a parameter representing a relationship between an electronic device and the target virtual object; and generating a feedback responsive to the parameter satisfying a preset condition.

### CROSS-REFERENCES TO RELATED APPLICATIONS

This application claims the priority of Chinese patent application No. 201810714482.5, filed on Jun. 29, 2018, the entire content of all of which is incorporated herein by reference.

### FIELD OF THE DISCLOSURE

The present disclosure relates to the field of augmented reality (AR) technologies and, more particularly, relates to a data processing method and an electronic device thereof.

### BACKGROUND

Augmented Reality (AR) technology is a new technology that seamlessly integrates real-world information with virtual-world information. AR technology displays not only the real-world information, but also the virtual information at the same time, in which the real-world information and the virtual information are complementary and superimposed. AR technology can display real objects and virtual objects in the same picture or same space. However, for users, displaying the real object and the virtual object in the same picture or same space is not enough, and a more realistic AR experience is highly desired by users.

### BRIEF SUMMARY OF THE DISCLOSURE

One aspect of the present disclosure provides a data processing method. The data processing method comprises acquiring a real scene; presenting a target virtual object corresponding to a sphere of influence in the real scene; obtaining a parameter representing a relationship between an electronic device and the target virtual object; and generating a feedback responsive to the parameter satisfying a preset condition.

Another aspect of the present disclosure provides an electronic device. The electronic device comprises a memory for storing code; and a processor coupled to the memory. The processor is operative to acquire a real scene, present a target virtual object corresponding to a sphere of influence in the real scene, obtain a parameter representing a relationship between an electronic device and the target virtual object, and generate a feedback responsive to the parameter satisfying a preset condition.

Another aspect of the present disclosure provides an electronic device. The electronic device comprises one or more processors, a memory having a code stored therein, the code being executable to: acquire a real scene; present a target virtual object corresponding to a sphere of influence in the real scene; acquire a parameter that represents a relationship between the electronic device and the target virtual object; and generate a feedback responsive to the parameter satisfying a preset condition.

Other aspects of the present disclosure may be understood by those skilled in the art in light of the description, the claims, and the drawings of the present disclosure.

### BRIEF DESCRIPTION OF THE DRAWINGS

To more clearly illustrate technical solutions of embodiments or in the prior art, accompany drawings which need to be used in the description of the embodiments or the prior art will be simply introduced. Obviously, the accompany drawings in the following description are merely some embodiments, and for those of ordinary skill in the art, other embodiments can further be obtained according to these accompany drawings without contributing any creative work.

FIG. 1 illustrates a flow chart of an exemplary data processing method consistent with disclosed embodiments;

FIG. 2 illustrates a sphere of influence of an exemplary target virtual object corresponding to a real scene consistent with disclosed embodiments;

FIG. 3 illustrates an exemplary electronic device consistent with disclosed embodiments; and

FIG. 4 illustrates a block diagram of an exemplary electronic device consistent with disclosed embodiments.

### DETAILED DESCRIPTION

Reference will now be made in detail to example of an embodiments of the disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

The present disclosure provides a data processing method and an electronic device capable of enhancing the realistic AR experience.

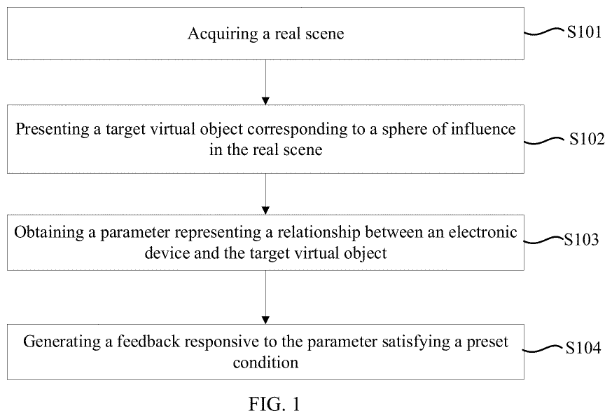

The present disclosure provides a data processing method, which is applicable but not limited to, a mobile phone, a PAD, and an AR glasses, etc. FIG. 1 illustrates a flow chart of an exemplary data processing method consistent with disclosed embodiments. As shown in FIG. 1, the data processing method may include acquiring a real scene, where acquiring a real scene includes acquiring a real scene via a scene acquiring device, such as a camera, and constructing a model corresponding to the real scene (S101). The data processing method may further include presenting a target virtual object, where the target virtual object corresponds to a sphere of influence in the real scene (S102).

In the disclosed embodiments, acquiring a real scene and presenting a target virtual object may be realized by at least the following two methods. In one embodiment, an electronic device such as a mobile phone or a PAD may acquire a real scene via a camera, build a model corresponding to the acquired real scene, then configure a target virtual object based on the built model corresponding to the real scene, such that the target virtual object and the real scene may be integrated. The target virtual object and the real scene may be displayed in the same screen, by display units of the electronic device.

In another embodiment, an electronic device such as AR glasses may acquire a real scene via a camera, and build a model corresponding to the acquired real scene. A user may observe the real scene via the naked eyes, and the electronic device may project the target virtual object to the human eyes based on the built model corresponding to the real scene, and the target virtual object may be imaged on the retina. Thus, the user may observe a virtual object at a certain location in the current real scene, and the virtual object may be fused with the real scene.

The data processing method may further include obtaining a parameter representing a relationship between an electronic device and the target virtual object (S103). In particular, the sphere of influence may include but not limited to the size of the target virtual object in the real scene, and the expansion range of the target virtual object in the real scene. For example, the target virtual object may be a virtual fan, and the sphere of influence of the target virtual object in the real scene may be an air supply range of the virtual fan in the real scene.

The data processing method may further include generating a feedback responsive to the parameter satisfying a preset condition (S104). In particular, responsive to the parameter satisfying the preset condition, the generated feedback may be one outputted by the electronic device which is currently viewed by the user. In one embodiment, the feedback outputted by the electronic device may be a non-display feedback.

For example, the target virtual object may be a virtual fan. When the electronic device is located in the air supply range of the virtual fan corresponding to the real scene, the electronic device may vibrate, thereby simulating the feeling of being blown by the air.

In the disclosed data processing method, first a real scene may be acquired, and a target virtual object may be presented, where the presented target virtual object corresponds to a sphere of influence in the real scene. Then a parameter that represents a relationship between the electronic device and the target virtual object (e.g., the sphere of influence) may be obtained. Response to the parameter satisfying a preset condition, a feedback may be generated. The disclosed data processing method may enable the user to interact with the virtual object via the electronic device, and to receive the feedback of the virtual object during the interaction, which provides more realistic AR experience and greatly improves the user experience.

In the disclosed embodiments, the parameter satisfying the preset condition may indicate that the electronic device is in the sphere of influence of the target virtual object corresponding to the real scene, or the electronic device is close to the sphere of influence of the target virtual object corresponding to the real scene, and the feedback may be generated.

In one embodiment, the sphere of influence of the target virtual object corresponding to the real scene may be the size of the target virtual object in the real scene. When the electronic device is located within the sphere of influence of the target virtual object corresponding to the real scene, the electronic device may be in contact with the target virtual object, or the electronic device may penetrate the target virtual object. When the electronic device is close to the sphere of influence of the target virtual object corresponding to the real scene, the electronic device may be close to the target virtual object.

In another embodiment, the sphere of influence of the target virtual object corresponding to the real scene may be an expansion range of the target virtual object in the real scene. When the electronic device is located in the sphere of influence of the target virtual object corresponding to the real scene, the electronic device may be located in the expansion range of the target virtual object in the real scene. For example, the target virtual object may be a virtual fan, the expansion range of the virtual fan in the real scene may be the air supply range of the virtual fan in the real scene, and the electronic device may be located in the air supply range of the virtual fan in the real scene.

In one embodiment, provided that the sphere of influence of the target virtual object corresponding to the real scene is the size of the target virtual object in the real scene, when the electronic device is close to or located in the sphere of influence of the target virtual object corresponding to the real scene, the feedback may be generated. For example, the target virtual object may be a virtual vase. The electronic device locating within the sphere of influence of the virtual vase corresponding to the real scene may indicate that the electronic device collides with the virtual vase, and the electronic device may be controlled to vibrate and generate a sound of the collision with the vase.

Further, the process of generating feedback may include determining the feedback according to parameter of the target virtual object, and generating the determined feedback.

In the real scene, an object may collide with a plurality of different objects, and the generated feedback may be different. For example, different types of sounds may be generated after an object collides with a vase, a wooden door, a metal door, or a floor. That is, the user may hear different types of sounds after an object collides with an object of different materials. Based on this, to provide the user with more realistic AR experience, in the disclosed embodiments, the feedback may be determined according to attribute parameters of the target virtual object, such as a parameter that represents the material of the target virtual object, such that the virtual objects having different attribute parameters may correspond to different feedback modes.

For example, the target virtual object may be a virtual vase. When the electronic device collides with the virtual vase, i.e., the electronic device may be located within the sphere of influence of the virtual vase corresponding to the real scene, the electronic device may be controlled to vibrate and generate a sound of the collision with the vase. For another example, the target virtual object may be a virtual tree. When the electronic device goes through the leaves and branches, i.e., the electronic device is located within the sphere of influence of the virtual tree corresponding to the real scene, the electronic device may be controlled to vibrate and generate a sound of shaking the leaves and branches. For another example, the target virtual object may be a virtual wooden door. When the electronic device collides with the virtual wooden door, i.e., the electronic device is located within the sphere of influence of the virtual wooden door corresponding to the real scene, the electronic device may be controlled to vibrate and generate a sound of the collision with the wooden door. For another example, the target virtual object may be a virtual metal door. When the electronic device collides with the virtual metal door, i.e., the electronic device is located within the sphere of influence of the virtual metal door corresponding to the real scene, the electronic device may be controlled to vibrate and generate a sound of the collision with the metal door.

In the disclose embodiments, existing resources in the electronic device may be fully utilized to generate the feedback, for example, a motor in the electronic device may be controlled to vibrate, and an audio output unit such as a speaker in the electronic device may be controlled to output sound.

In one embodiment, the parameter in the disclosed data processing method may include but not limited to one which indicates a location change of the electronic device. Then obtaining the parameter (S103) may include: acquiring, by an acceleration sensor in the electronic device, a parameter which represents a location change of the electronic device, and generating a feedback responsive to the parameter satisfying a preset condition (S104) may include: generating a feedback responsive to the parameter that representes the location change of the electronic device indicating that the electronic device is located in the sphere of influence of the target virtual object corresponding to the real scene. In particular, based on the parameter that represents the location change of the electronic device, a relative distance and/or a relative direction of the electronic device and the target virtual object may be determined. Based on the determined relative distance and/or relative direction of the electronic device and the target virtual object, whether or not the electronic device is within the sphere of influence of the target virtual object corresponding to the real scene may be determined. In response to determining that the electronic device is within the sphere of influence of the target virtual object corresponding to the real scene, a feedback may be generated.

Further, when the sphere of influence of the target virtual object corresponding to the real scene is the expansion range of the target virtual object in the real scene, generating a feedback responsive to the parameter satisfying a preset condition (S104) may include: determining a feedback strength based on the relative distance and/or relative direction of the electronic device with respect to the target virtual object, and generating a feedback based the determined feedback strength.

Given a fixed relative direction of the electronic device with respect to the target virtual object but a changing relative distance of the electronic device with respect to the target virtual object, the feedback strength may be different. For example, the closer the electronic device is to the target virtual object, the greater the feedback strength, and the farther the electronic device is to the target virtual object, the weaker the feedback strength. That is, as the electronic device gradually gets close to the target virtual object, the feedback strength may be gradually increased, and as the electronic device gradually gets far away from the target virtual object, the feedback strength may be gradually decreased.

Similarly, given a changing relative direction of the electronic device with respect to the target virtual object but a fixed relative distance of the electronic device with respect to the target virtual object, the feedback strength may be different. Given a changing relative direction of the electronic device with respect to the target virtual object and a changing relative distance of the electronic device with respect to the target virtual object, the feedback strength may be different. In summary, given a changing relative direction of the electronic device with respect to the target virtual object and/or a changing relative distance of the electronic device with respect to the target virtual object, the feedback strength may be different.

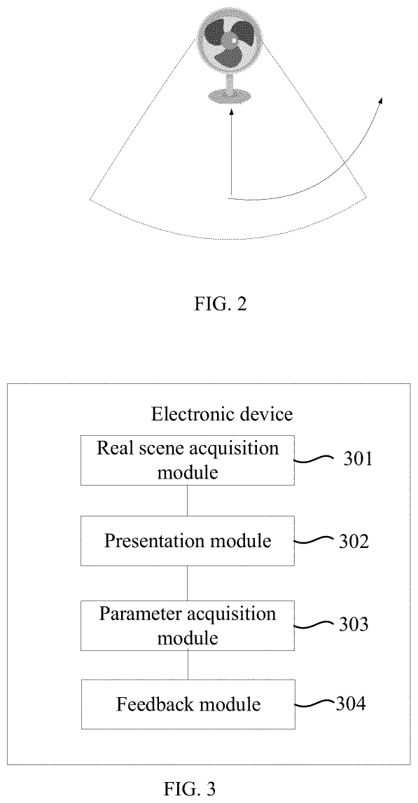

For example, a virtual fan capable of blowing air may be disposed on a real desktop in a real scene, and the cross-section of the air supply range of the virtual fan in the real scene may be a fan shape or a sector, as shown in FIG. 2. In real life, when the user is in the air supply range of the fan, the user may feel the air, and when the user is beyond the air supply range of the fan, the user may not feel the air. Based on this, provided that the virtual fan does not swing when blowing the air, to provide more realistic user experience, when the electronic device held by the user is located in the air supply range of the virtual fan in the real scene, such as located at the front side of the virtual fan and the distance between the electronic device and the virtual fan is smaller than the radius of the sector, the electronic device may be controlled to vibrate. When the user is holding the electronic device and rotating around the virtual fan, the relative distance and/or relative direction of the electronic device and the virtual fan may be determined based on the position change of the electronic device. Then based on the determined relative distance and/or relative direction of the electronic device and the virtual fan, whether or not the electronic device is in the air supply range of the virtual fan in the real scene may be determined. In response to determining the electronic device is in the air supply range of the virtual fan in the real scene, the electronic device may be controlled to vibrate. In response to determining the electronic device is beyond the air supply range of the virtual fan in the real scene, the electronic device may be controlled to not vibrate. For example, when the user is holding the electronic device and rotating to the back of the virtual fan, the electronic device be controlled to not vibrate.

In real life, provided that the user is in the air supply range of the fan, as the user gradually gets close to the fan, the felt strength of the air may increase. Conversely, as the user gradually gets far away from the fan, the felt strength of the air may decrease. As the user turns around the fan from the front of the fan to the back of the fan, the felt strength of the air may be different, and given a constant distance between the user and the fan during the rotation, the felt strength of the air may gradually decrease to zero. Based on this, to provide more realistic user experience, when the electronic device held by the user is located in the air supply range of the virtual fan in the real scene, the vibration intensity may be determined based on the relative distance and/or relative direction of the electronic device and the virtual fan, and the electronic device may be controlled to vibrate according to the determined vibration intensity.

For example, the electronic device may be located in the air supply range of the virtual fan in the real scene and located directly in front of the virtual fan, as the user is holding the electronic device and gradually approaching the virtual fan, the vibration intensity of the electronic device may be controlled to gradually increase. In contrary, as the user is holding the electronic device and gradually moving away from the virtual fan, the vibration intensity of the electronic device may be controlled to gradually decrease. For another example, the electronic device may be located in the air supply range of the virtual fan in the real scene, as the user is holding the electronic device and continuously turning from the front of the virtual fan to the back of the fan, the vibration intensity of the control electronics may be controlled to gradually reduce to zero.

It should be noted that, during the movement of the electronic device, the sphere of influence of the target virtual object in the real scene may not move. In certain embodiments, the sphere of influence of the target virtual object in the real scene may move, for example, the virtual fan may swing and, accordingly, the virtual fan's air supply range in the real scene may move. In this case, a current sphere of influence of the target virtual object corresponding to the real scene may be first obtained, then whether or not the electronic device is in the current sphere of influence of the target virtual object corresponding to the real scene may be determined. In response to determining the electronic device is in the current sphere of influence of the target virtual object corresponding to the real scene, a feedback may be generated.

It should be noted that, during the movement of the sphere of influence of the target virtual object corresponding to the real scene, the electronic device may or may not move. No matter the electronic device moves or not, whether the electronic device is in the current sphere of influence of the target virtual object corresponding to the real scene may be determined based on the current location information of the electronic device and the current sphere of influence of the target virtual object corresponding to the real scene. In response to determining that the electronic device is in the current sphere of influence of the target virtual object corresponding to the real scene, a feedback may be generated. In response to determining that the electronic device is beyond the current sphere of influence of the target virtual object corresponding to the real scene, a feedback may be not generated.

In addition, in response to determining that the electronic device is in the current sphere of influence of the target virtual object corresponding to the real scene, the feedback strength may be determined based on the relative distance and/or the relative direction of the electronic device with respect to the target virtual object, and the electronic device may be controlled to generate a feedback based on the feedback strength. Thus, as the relative distance and/or the relative direction of the electronic device with respect to the target virtual object varies, the feedback strength may vary accordingly. For example, as the relative distance between the electronic device and the target virtual object decreases, the feedback strength may increase, and as the relative distance between the electronic device and the target virtual object increases, the feedback strength may decrease.

For example, a virtual fan may be placed on a real desktop in a real scene, and the virtual fan may swing. That is, the air supply range of the virtual fan in the real scene may move. In the real scene, as the user is stationary while the fan is swinging, the user may or may not feel the air. The fan may allow the user to be in the air supply range of the fan through swinging, such that the user may feel the air. On the other hand, the fan may allow the user to be beyond the air supply range of the fan through swinging, such that the user may not feel the air. Based on this, for the virtual fan, the electronic device may acquire the current air supply range of the virtual fan in the real scene, and determine whether or not the electronic device is in the current air supply range of the virtual fan in the real scene. In response to determining the electronic device is in the current air supply range of the virtual fan in the real scene, the electronic device may be controlled to vibrate. In response to determining the electronic device is beyond the current air supply range of the virtual fan in the real scene, the electronic device may be controlled to not vibrate.

No matter the electronic device moves or not, whether or not the electronic device is in the current air supply range of the virtual fan in the real scene may be determined based on the current position information of the electronic device and the current air supply range of the virtual fan in the real scene, and the vibration of the electronic device may be controlled. In response to determining the electronic device is in the current air supply range of the virtual fan in the real scene, the electronic device may be controlled to vibrate. In response to determining the electronic device is beyond the current air supply range of the virtual fan in the real scene, the electronic device may be controlled to not vibrate.

In addition, when the electronic device is located in the air supply range of the virtual fan in the real scene, the vibration intensity may also be determined based on the relative distance and/or the relative direction of the electronic device with respect to the virtual fan, and the vibration of the electronic device may be controlled based on the determined vibration intensity. Thus, as the relative distance and/or the relative direction of the electronic device with respect to the virtual fan varies, the vibration intensity may also vary.

In another embodiment, the parameter may be a display parameter of the target virtual object. As the electronic device gradually gets close to the target virtual object, the size of the target virtual object in the picture presented by the electronic device may gradually increase, and as the electronic device gradually gets far away from the target virtual object, the size of the target virtual object in the picture presented by the electronic device may gradually decrease. The size of the target virtual object presented by the electronic device may be represented by the display parameter of the target virtual object.

In particular, the display parameter may include one that represents the size of the target virtual object presented by the electronic device, and one that represents the angle of the target virtual object presented by the electronic device. The size and angle of the target virtual object presented by the electronic device may be related to the distance and direction of the electronic device relative to the target virtual object. Therefore, based on the display parameter of the target virtual object, the distance and/or direction of the electronic device relative to the target virtual object may be determined.

That is, in the disclosed data processing method, responsive to the parameter satisfying the preset condition, the process of generating the feedback may include: generating a feedback when the display parameter indicates that the electronic device is located within the sphere of influence of the target virtual object corresponding to the real scene. In particular, the distance and/or direction of the electronic device relative to the target virtual object may be determined based on the display parameter of the target virtual object (such as a display parameter that represents the size of the target virtual object presented by the electronic device, and/or a display parameter that represents the angle of the target virtual object presented by the electronic device). Based on the determined distance and/or direction of the electronic device relative to the target virtual object, whether or not the electronic device is located within the sphere of influence of the target virtual object corresponding to the real scene may be determined. In response to determining the electronic device is located within the sphere of influence of the target virtual object corresponding to the real scene, a feedback may be generated. In certain embodiments, a mapping relationship between the display parameter and the distance and/or direction of the electronic device relative to the target virtual object may be preset. In response to acquiring the display parameter, the distance and/or direction of the electronic device relative to the target virtual object may be determined based on the mapping relationship.

Further, the sphere of influence of the target virtual object corresponding to the real scene may be an expansion range of the target virtual object in the real scene, a feedback strength may be determined based on the relative distance and/or relative direction of the electronic device with respect to the target virtual object and, further, a feedback may be generated based the determined feedback strength. Thus, as the relative distance and/or relative direction of the electronic device with respect to the virtual fan varies, the feedback strength may also vary, thereby providing more realistic AR experience.

The present disclosure further provides an electronic device. The electronic device may be but not limited to, a mobile phone, a PAD, and an AR glasses, etc. FIG. 3 illustrates an exemplary electronic device consistent with disclosed embodiments. As shown in FIG. 3, the electronic device may include a real scene acquisition module 301, a presentation module 302, a parameter acquisition module 303, and a feedback module 304. In particular, the real scene acquisition module 301 may acquire a real scene. The presentation module 302 may present a target virtual object, where the target virtual object may correspond to a sphere of influence in the real scene. The parameter acquisition module 303 may acquire a parameter which represents a relationship between the electronic device and the target virtual object. The feedback module 304 may generate a feedback responsive to the parameter satisfying a preset condition.

In the disclosed embodiments, the electronic device may first acquire the real scene and present the target virtual object corresponding to the sphere of influence in the real scene, then acquire the parameter that represents a relationship between the electronic device and the target virtual object, and generate the feedback responsive to the parameter satisfying the preset condition. Thus, the electronic device may enable the user to interact with the virtual object and receive feedback of the virtual object during the interaction, which provides more realistic AR experience and greatly improves the user experience.

In one embodiment, the parameter acquired by the parameter acquisition module 303 may be a parameter which represents a location change of the electronic device. The parameter acquisition module 303 may acquire the parameter which represents a location change of the electronic device, via an acceleration sensor in the electronic device. Based on the acquired parameter which represents a location change of the electronic device, the feedback module 304 may determine a relative distance and/or a direction of the electronic device with respect to the target virtual object. Based on the determined relative distance and/or a direction of the electronic device with respect to the target virtual object, the feedback module 304 may determine whether or not the electronic device is within the sphere of influence of the target virtual object corresponding to the real scene. In response to determining that the electronic device is within the sphere of influence of the target virtual object corresponding to the real scene, the feedback module 304 may generate a feedback.

In one embodiment, the parameter acquired by the parameter acquisition module 303 may be a display parameter of the target virtual object. Based on the acquired display parameter of the target virtual object, the feedback module 304 may determine a relative distance and/or a relative direction of the electronic device with respect to the target virtual object. Based on the relative distance and/or relative direction of the electronic device with respect to the target virtual object, the feedback module 304 may determine whether or not the electronic device is located within the sphere of influence of the target virtual object corresponding to the real scene. In response to determining the electronic device is located within the sphere of influence of the target virtual object corresponding to the real scene, the feedback module 304 may generate a feedback.

Further, based on the relative distance and/or relative direction of the electronic device with respect to the target virtual object, the feedback module 304 may determine a feedback strength, then generate a feedback based on the determined feedback strength.

In one embodiment, the sphere of influence may include a size of the target virtual object in the real scene, or an expansion range of the target virtual object in the real scene. In one embodiment, the feedback may be one outputted by the electronic device which is currently viewed by the user. In one embodiment, the feedback generated by the feedback module 304 may be a non-displayed feedback. In one embodiment, the feedback module 304 may determine the feedback according to an attribute parameter of the target virtual object, and generate the determined feedback. In one embodiment, the feedback module 304 may generate a feedback when the parameter indicates that the electronic device is close to the sphere of influence of the target virtual object. In one embodiment, the sphere of influence of the target virtual object may move, where the movement of the sphere of influence of the target virtual object may include a movement of the sphere of influence of the target virtual object itself, and/or a movement of the sphere of influence of the target virtual object caused by the electronic device.

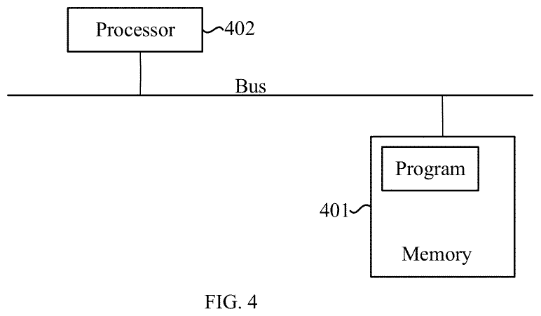

The present disclosure further provides an electronic device. FIG. 4 illustrates a block diagram of an exemplary electronic device consistent with disclosed embodiments. Referring to FIG. 4, the electronic device may include a memory 401 and a processor 402. The memory 401 may store a program, which may be executed by the processor 402. When being execute by the processor 402, the program may acquire a real scene, present a target virtual object corresponding to a sphere of influence in the real scene, acquire a parameter that represents a relationship between the electronic device and the target virtual object, and generate a feedback responsive to the parameter satisfying a preset condition.

The processor 402 and the memory 401 may be coupled to each other through a bus, where the bus may include a path to transfer information among various components.

The processor 402 may include a general-purpose processor, such as a general-purpose central processing unit (CPU), a microprocessor, etc., or an application-specific integrated circuit (ASIC), or one or more integrated circuits for controlling the execution of the program. The processor 402 may include a digital signal processor (DSP), an application specific integrated circuit (ASIC), a field programmable gate array (FPGA) or other programmable logic devices, a discrete gate or transistor logic device, or a discrete hardware component. The processor 402 may include a main processor, a baseband chip, and a modem, etc.

The memory 401 may store a program for executing various steps in the disclosed data processing method, and also store an operating system and other key services. In particular, the program may include a program code, and the program code may include computer operating instructions. More specifically, the memory 401 may include a read-only memory (ROM), other types of static storage devices that store static information and instructions, random access memory (RAM), other types of dynamic storage devices that store information and instructions, disk storage, flash, and so on.

The processor 402 may execute the program stored in the memory 401 and call other devices. The processor 402 may perform various steps in the disclosed data processing method.

The present disclosure further provides a computer readable storage medium, which may store a computer program. When executed by the processor, the computer program may cause the processor to perform the various steps in the disclosed data processing method, and any variations thereof.

In the disclosed embodiments, the user may observe that a real world is superimposed with a virtual object when viewing through an electronic device capable of providing AR scene, i.e., an AR electronic device. For the characteristics of the virtual object, the AR electronic device may provide a real feedback based on the virtual object, i.e., the AR electronic device that may provide the user a real feedback, such that the user may feel the virtual object superimposed and displayed in the real world is close to the real world.

Various embodiments of the present specification may be described in a progressive manner, in which each embodiment focusing on aspects different from other embodiments, and the same and similar parts of each embodiment may be referred to each other.

In the several embodiments provided in the present disclosure, it should be understood that the disclosed system, apparatus, and method may be implemented in other manners. For example, the described apparatus embodiment may be merely exemplary. For example, the unit division may be merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, which may be located in one position, or may be distributed on a plurality of network units. A part or all of the units may be selected according to actual needs to achieve the objectives of the solutions in the embodiments.

In addition, functional units in the embodiments of the present disclosure may be integrated into one processing unit, or each of the units may exist alone physically, or two or more units may be integrated into one unit. The integrated unit may be implemented in the form of hardware, or may be implemented in the form of hardware combining a software functional unit.

The foregoing integrated unit implemented in the form of a software functional unit may be stored in a computer-readable storage medium. The foregoing software functional unit may be stored in a storage medium, and may include a plurality of instructions used to enable a computer device (which may be a personal computer, a server, a network device, or the like) or a processor to execute a part of steps of the method described in the embodiments of the present disclosure. The storage medium may include: any medium that can store program code, such as a USB flash disk, a removable hard disk, a read-only memory (ROM), a random access memory (RAM), a magnetic disk, or an optical disc.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A data processing method, comprising:
acquiring a real scene;
presenting a target virtual object corresponding to a sphere of influence in the real scene;
obtaining a parameter representing a relationship between an electronic device and the target virtual object; and
generating a feedback responsive to the parameter satisfying a preset condition.

2. The data processing method according to claim 1, wherein:
the parameter represents a location change of the electronic device,
wherein the obtaining the parameter representing the relationship between the electronic device and the target virtual object further comprises:
acquiring, via an acceleration sensor in the electronic device, the parameter that represents the location change of the electronic device, and
wherein the generating the feedback responsive to the parameter satisfying the preset condition further comprises:
based on the parameter that represents the location change of the electronic device, determining a relative distance and/or a relative direction of the electronic device with respect to the target virtual object,
based on the determined relative distance and/or relative direction of the electronic device with respect to the target virtual object, determining whether or not the electronic device is within the sphere of influence, and
in response to determining that the electronic device is within the sphere of influence, generating the feedback.

3. The data processing method according to claim 1, wherein:
the parameter is a display parameter of the target virtual object,
wherein the generating the feedback responsive to the parameter satisfying the preset condition further comprises:
based on the display parameter of the target virtual object, determining a relative distance and/or a relative direction of the electronic device with respect to the target virtual object,
based on the determined relative distance and/or relative direction of the electronic device with respect to the target virtual object, determining whether or not the electronic device is within the sphere of influence, and
in response to determining that the electronic device is within the sphere of influence, generating the feedback.

4. The data processing method according to claim 2, wherein the generating the feedback responsive to the parameter satisfying the preset condition further comprises:
determining a feedback strength based on the determined relative distance and/or relative direction of the electronic device with respect to the target virtual object, and
generating the feedback based on the determined feedback strength.

5. The data processing method according to claim 1, wherein:
the sphere of influence is a size of the target virtual object in the real scene.

6. The data processing method according to claim 1, wherein:
the sphere of influence is an expansion range of the target virtual object in the real scene.

7. The data processing method according to claim 1, wherein:
the generated feedback is outputted by the electronic device which is currently viewed by the user, and the feedback outputted by the electronic device is a non-display feedback.

8. The data processing method according to claim 1, wherein the generating the feedback responsive to the parameter satisfying the preset condition further comprises:
determining the feedback based on an attribute parameter of the target virtual object; and
generate the feedback.

9. The data processing method according to claim 1, wherein the generating the feedback responsive to the parameter satisfying the preset condition further comprises:
generating the feedback when the electronic device is close to the sphere of influence of the target virtual object.

10. The data processing method according to claim 1, wherein:
the sphere of influence of the target virtual object is moveable,
wherein a movement of the sphere of influence of the target virtual object includes at least one of a movement caused by the target virtual object itself and a movement caused by the electronic device.

11. An electronic device, comprising one or more processors, a memory having a code stored therein, the code being executable to:
acquire a real scene;
present a target virtual object corresponding to a sphere of influence in the real scene;
acquire a parameter that represents a relationship between the electronic device and the target virtual object; and
generate a feedback responsive to the parameter satisfying a preset condition.

12. The electronic device according to claim 11, wherein:
the parameter represents a location change of the electronic device,
wherein the code is executable to:
acquire the parameter that represents the location change of the electronic device via an acceleration sensor in the electronic device,
determine a relative distance and/or a relative direction of the electronic device with respect to the target virtual object based on the parameter that represents the location change of the electronic device,
determine whether or not the electronic device is within the sphere of influence, based on the determined relative distance and/or relative direction of the electronic device with respect to the target virtual object, and
generate the feedback responsive to determining that the electronic device is within the sphere of influence.

13. The electronic device according to claim 11, wherein:
the parameter is a display parameter of the target virtual object,
wherein the code is executable to:
determine a relative distance and/or a relative direction of the electronic device with respect to the target virtual object based on the display parameter of the target virtual object,
determine whether or not the electronic device is within the sphere of influence based on the determined relative distance and/or relative direction of the electronic device with respect to the target virtual object, and
generate the feedback responsive to determining that the electronic device is within the sphere of influence.

14. An electronic device, comprising:
a memory for storing code; and
a processor coupled to the memory,
wherein the processor is operative to
acquire a real scene,
present a target virtual object corresponding to a sphere of influence in the real scene,
obtain a parameter representing a relationship between an electronic device and the target virtual object, and
generate a feedback responsive to the parameter satisfying a preset condition.

15. The electronic device according to claim 14, wherein:
the parameter represents a location change of the electronic device,
wherein the processor is operative to:
acquire the parameter that represents the location change of the electronic device via an acceleration sensor in the electronic device,
determine a relative distance and/or a relative direction of the electronic device with respect to the target virtual object based on the parameter that represents the location change of the electronic device,
determine whether or not the electronic device is within the sphere of influence, based on the determined relative distance and/or relative direction of the electronic device with respect to the target virtual object, and
generate the feedback responsive to determining that the electronic device is within the sphere of influence.

16. The electronic device according to claim 14, wherein:
the parameter is a display parameter of the target virtual object,
wherein the processor is operative to:
determine a relative distance and/or a relative direction of the electronic device with respect to the target virtual object based on the display parameter of the target virtual object,
determine whether or not the electronic device is within the sphere of influence based on the determined relative distance and/or relative direction of the electronic device with respect to the target virtual object, and
generate the feedback responsive to determining that the electronic device is within the sphere of influence.
